(19) United States
(12) Patent Application Publication
(10) Pub. No.: US 2006/0285719 A1
(43) Pub. Date: Dec. 21, 2006

(54) DIGITAL WATERMARKING SYSTEM ACCORDING TO PIXEL DISPLAY PROPERTY AND DIGITAL WATERMARKING METHOD

(76) Inventors: Kuan-Hong Hsieh, Shenzhen (CN); Xiao-Fang Chen, Shenzhen (CN); Zai-An Pan, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,550

(22) Filed: Feb. 13, 2006

(30) Foreign Application Priority Data
Jun. 17, 2005 (CN) 200510035402.6

(51) Int. Cl. G06K 9/00

(52) U.S. Cl. 382/100

(57) ABSTRACT

A digital watermarking system and method is provided. The digital watermarking system mainly includes a storing unit, a text obtaining module, a pixel determining module, an encrypting module, and a storing module. The storing unit is for storing text information, the text information including one or more dot matrix files. The text obtaining module is for obtaining one dot matrix file to be watermarked from the storing unit. The dot matrix file includes plural dot matrixes, each of which includes plural pixels, each pixel possessing a display property. The pixel determining module is for earmarking the pixel to be adjusted to obtain a watermark. The encrypting module is for adjusting the display property the earmarked pixel. The storing module is for storing watermarked text information in the storing unit. Related methods are provided.

### DESCRIPTION

1. Technical Field

The present invention relates to a digital rights protection system and method, and particularly to a digital watermarking system implemented according to a pixel display property and a related digital watermarking method.

2. General Background

The threat of pirating of digitally-formatted works has been a significant obstacle to widespread adoption and use of the Internet for distribution of media such as books, musical works, and motion pictures. Although such network distribution would at first glance seem ideal for these media, which are easily represented in electronic format, there has been no easy way to prevent widespread copying of such works once they are introduced to the public. In many cases, one person will buy a legitimate copy and then distribute copies thereof to friends and others without any further payments to the publisher. This threatens the financial well-being of the publishers, and makes them very reluctant to introduce their works on the Internet.

Therefore, in order to try to solve the above described problems, digital watermarking has been developed. In general, digital watermarking is an alteration of a data set within an electronic file. The watermark can be visible or invisible to human perception.

The invisible, or nearly invisible, watermark is mainly detected by a computer. The computer computes a correlation of the information under scrutiny with an applied watermark pattern, and compares the result of the correlation with a predetermined threshold difference. If the difference of the result is greater than the threshold difference, the watermark is said to be present; otherwise, it is said to be absent. The greater the difference, the more reliable the detection result is. However, with respect to a work embedded with such a watermark, a great deal of computing is needed to detect the watermark and identify copyright notices or other verification messages in the work. In addition, once the work is printed, it becomes more difficult to accurately read or interpret the information contained in the watermark, due to the imperceptible characteristics of the watermark.

What is needed, therefore, is a digital watermarking system and method, which can efficiently watermark text and generate a perceptible watermark.

### SUMMARY

A digital watermarking system is provided. The digital watermarking system mainly includes a storing unit, a text obtaining module, a pixel determining module, an encrypting module, and a storing module. The storing unit is for storing text information, the text information including one or more dot matrix files. The text obtaining module is for obtaining a dot matrix file to be watermarked from the storing unit. The dot matrix file includes a plurality of dot matrixes, each of the dot matrixes includes a plurality of pixels, and each of the pixels has a display property. The pixel determining module is for earmarking the pixel to be adjusted to obtain a watermark. The encrypting module is for adjusting the display property of the earmarked pixel, the adjustment being either adjusting from visible to invisible or from invisible to invisible. The storing module is for storing watermarked text information in the storing unit.

A digital watermarking method is also provided. The method includes the steps of: (a) obtaining text information to be watermarked, the text information including one or more dot matrix files each of which includes a plurality of dot matrixes, each dot matrix including a plurality of pixels each of which has a display property; (b) earmarking the pixel to be adjusted to obtain a watermark; (c) adjusting the display property of the earmarked pixel, the adjustment being either to adjust from visible to invisible or from invisible to visible; and (d) storing watermarked text information in a storing unit.

Another digital watermarking method is further provided. The method includes the steps of: (a) obtaining text information to be watermarked, the text information including one or more dot matrix files each of which includes a plurality of dot matrixes, each of the dot matrixes includes a plurality of pixels, and each of the pixels has a display property; (b) obtaining a dot matrix from the obtained text information if a length of a bit sequence is not equal to zero, the bit sequence being for indicating copyright, author, etc; (c) earmarking the pixel of the obtained dot matrix to be adjusted according to a bit value of one bit of the bit sequence; (d) adjusting the brightness value of the earmarked pixel; (e) recording the adjusted pixel and corresponding bit value; and (f) storing watermarked text information.

Other advantages and novel features will be drawn from the following detailed description with reference to the attached drawings, in which:

### BRIEF DESCRIPTION OF DRAWINGS

FIG. 1 is a schematic diagram of an exemplary dot matrix file in accordance with a preferred embodiment of the present invention, the dot matrix file including a plurality of dot matrixes;

FIG. 2 is a schematic diagram of an exemplary dot matrix of the dot matrix file of FIG. 1, the dot matrix including a plurality of pixels;

FIG. 3 is a schematic diagram of main function modules of a digital watermarking system in accordance with a preferred embodiment of the present invention;

FIG. 4 is a flowchart of a preferred method for digital watermarking in accordance with another embodiment of the present invention;

FIG. 5 is a flowchart of a first preferred method of implementing one step of FIG. 4, namely determining pixels to be adjusted;

FIG. 6 is flowchart of a second preferred method of implementing the same step of FIG. 4, namely determining pixels to be adjusted;

FIG. 7 is a flowchart further detailing steps involved in digital watermarking utilizing a combination of the preferred methods of FIGS. 4 and 5;

FIG. 8 is a flowchart further detailing steps involved in digital watermarking utilizing a combination of the preferred methods of FIGS. 4 and 6;

FIG. 9A is a schematic diagram showing normal display states of pixels of FIG. 2 before watermarking, showing two pixels which are earmarked for adjustment;

FIG. 9B is similar to FIG. 9A, but showing the display states of the pixels after the two earmarked pixels have been adjusted; and

FIG. 10 illustrates exemplary adjustment results of a watermarked dot matrix obtained by utilizing the method of either FIG. 7 or FIG. 8.

### DETAILED DESCRIPTION

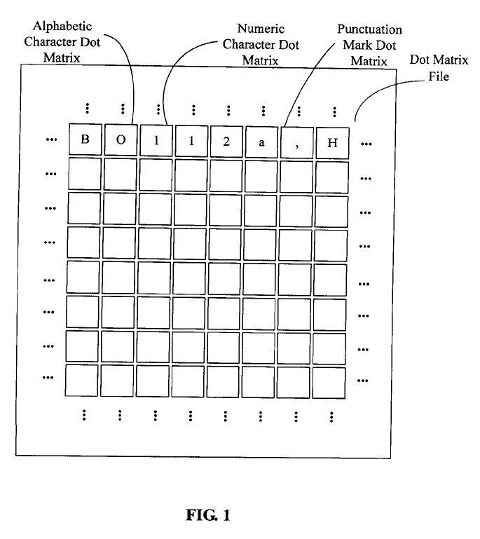

FIG. 1 is a schematic diagram of an exemplary dot matrix file in accordance with a preferred embodiment of the present invention, the dot matrix file including a plurality of dot matrixes. Generally, a text comprises a collection of data of a regular structure representing such things as characters and punctuation marks. The characters can be either alphabetic characters or numeric characters. Each character, as well as each punctuation mark, is represented by and stored as a dot matrix. Correspondingly, the dot matrixes are grouped into two sorts based on their type; i.e., alphanumeric character or punctuation. In this description, unless the context indicates otherwise, alphanumeric means alphabetic or numeric.

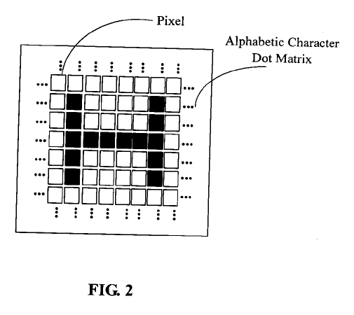

FIG. 2 is a schematic diagram of an exemplary dot matrix of the dot matrix file of FIG. 1. The dot matrix includes a plurality of pixels each being represented by a square. Each pixel has a display property indicated by the square thereof. For example, when the square is a black square, the display property of the corresponding pixel is visible. Conversely, when the square is a white square, the display property of the corresponding pixel is invisible.

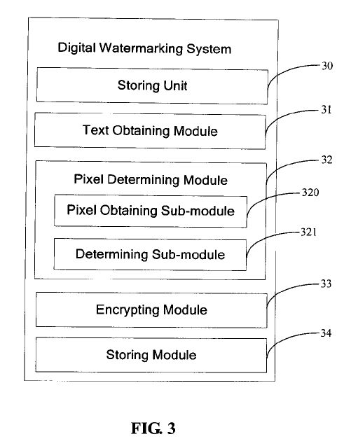

FIG. 3 is a schematic diagram of main function modules of a digital watermarking system in accordance with a preferred embodiment of the present invention. The digital watermarking system mainly includes a storing unit 30, a text obtaining module 31, a pixel determining module 32, an encrypting module 33, and a storing module 34. The storing unit 30 is provided for storing dot matrix files of texts and bit sequences. The bit sequences are the instructions for watermarking the texts. The text obtaining module 31 is for obtaining the dot matrix file to be watermarked from the storing unit 30.

The pixel determining module 32 is for determining pixels to be adjusted. The pixel determining module 32 further includes a pixel obtaining sub-module 320 and a determining sub-module 321. The pixel obtaining sub-module 320 is for obtaining the pixels to be adjusted. The determining sub-module 321 is for determining the display properties of the obtained pixels. Further, the determining sub-module 321 is capable of determining a type of each obtained pixel. That is, the determining sub-module 321 can determine whether the obtained pixel belongs to a dot matrix that represents an alphanumeric character (i.e., an alphabetic character or a numeric character). Preferably, the obtained pixel is an alphanumeric character type pixel, not a punctuation pixel. In such case, the obtained pixel is considered to be suitable for watermarking. In this description, this kind of pixel is referred to as an earmarked pixel.

The encrypting module 33 is for adjusting the display properties of the earmarked pixels as provided by the pixel determining module 32. For example, when the display property of an earmarked pixel is visible (i.e., indicated by a black square), the encrypting module 33 adjusts the display property of the earmarked pixel from visible to invisible. Conversely, when the display property of an earmarked pixel is invisible (i.e., indicated by a white square), the encrypting module 33 adjusts the display property of the earmarked pixel from invisible to visible. Therefore each of the adjusted pixels has a display property opposite to its normal display property, and the adjusted pixels collectively provide a means of watermarking. The storing module 34 is for storing the watermarked dot matrix files in the storing unit 30.

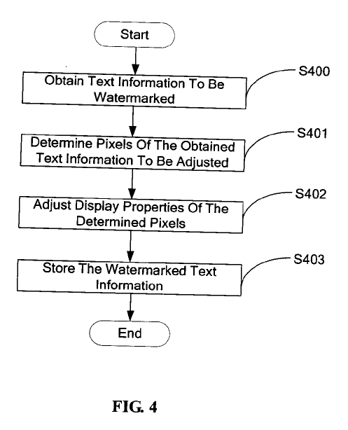

FIG. 4 is a flowchart of a preferred method for digital watermarking in accordance with the present invention. In step S400, the text obtaining module 31 obtains text information, e.g., a dot matrix file, to be watermarked from the storing unit 30. In step S401, the pixel determining module 32 determines which pixels of the obtained dot matrix file are to be adjusted. The earmarked pixels preferably are alphanumeric character type pixels. In step S402, the encrypting module 33 adjusts the display properties of the earmarked pixels. The adjustment of each earmarked pixel can be either an adjustment from visible to invisible or an adjustment from invisible to visible. For example, when the display property of an earmarked pixel is visible, the encrypting module 33 adjusts the display property from visible to invisible. Similarly, when the display property of an earmarked pixel is invisible, the encrypting module 33 adjusts the display property from invisible to visible. In step S403, the storing module 35 stores the watermarked dot matrix in the storing unit 30.

Consequently, by utilizing the steps of FIG. 4, the adjusted pixels have opposite display properties as compared to their normal display properties. Thereby, the adjusted pixels are perceptually different from their normal display. Therefore, the human eye can recognize and distinguish the adjusted pixels from the unadjusted pixels in the text.

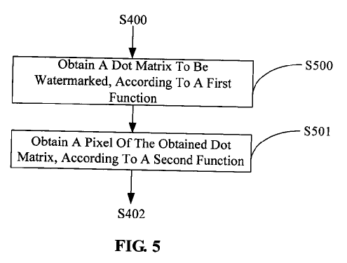

FIG. 5 is a flowchart of a first preferred method of implementing step S401 of FIG. 4, namely determining pixels to be adjusted. In step S500, the pixel obtaining sub-module 320 obtains a dot matrix from the text obtaining module 31, according to a first function as would be known to persons skilled in the relevant art(s). In step S501, the pixel obtaining sub-module 320 obtains a pixel of the obtained dot matrix, according to a second function as would be known to persons skilled in the relevant art(s), whereupon the procedure goes to step S402 described above. Therefore, by utilizing the steps of FIG. 5, a pixel is obtained.

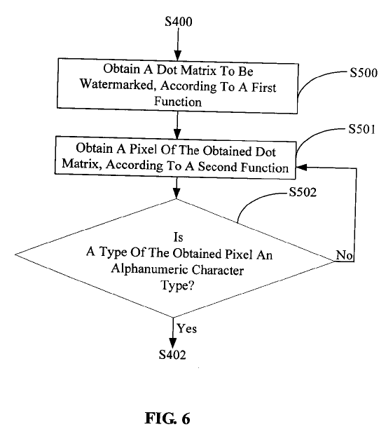

FIG. 6 is a flowchart of a second preferred method of implementing step S401 of FIG. 4, namely determining pixels to be adjusted. The steps of this flowchart are the same as those of FIG. 5, except that in an additional step S502, the determining sub-module 321 determines whether the obtained pixel is an alphanumeric character type pixel. If the obtained pixel is not an alphanumeric character type pixel, the procedure goes back to step S501 to obtain a new pixel. Conversely, if the obtained pixel is an alphanumeric character type pixel, the procedure goes to step S402 described above. Therefore, by utilizing the steps of FIG. 6, an alphanumeric character type pixel is obtained.

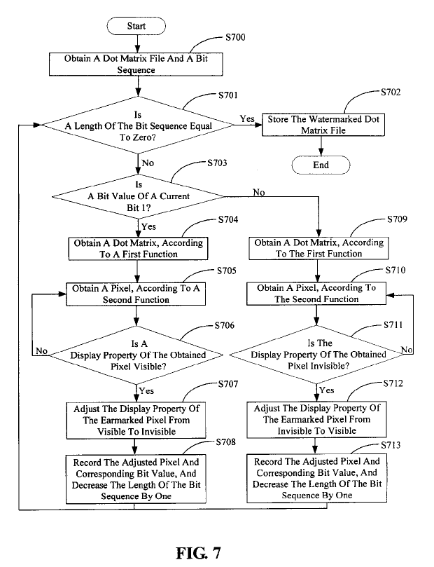

FIG. 7 is a flowchart further detailing steps involved in digital watermarking utilizing a combination of the preferred methods of FIGS. 4 and 5. In step S700, the text obtaining module 31 obtains a dot matrix file to be watermarked and a bit sequence for watermarking from the storing unit 30. The bit sequence may be information indicative of copyright, author, etc. In step S701, the determining sub-module 321 determines whether a length of the bit sequence is equal to zero. If the length of the bit sequence is equal to zero, in step S702, the storing module 34 stores the watermarked dot matrix file, and the procedure is finished. If the length of the bit sequence is not equal to zero, in step S703, the determining sub-module 321 determines whether a bit value of a current obtained bit of the bit sequence is a first value, for example, ‘1’. If the bit value of the current bit is ‘1’, in step S704, the pixel obtaining sub-module 320 obtains a dot matrix from the obtained dot matrix file according to the first function. In step S705, the pixel obtaining sub-module 320 obtains a pixel from the obtained dot matrix according to the second function. In step S706, the determining sub-module 321 determines whether the display property of the obtained pixel is visible. If the display property of the obtained pixel is not visible, the procedure goes back to step S705 to obtain a new pixel. If the display property of the obtained pixel is visible, in step S707, the encrypting module 33 adjusts the display property of the earmarked pixel from visible to invisible, thereby generating an adjusted pixel. In step S708, the storing module 34 records the adjusted pixel and the corresponding bit value (i.e., ‘1’), and decreases the length of the bit sequence by one, whereupon the procedure goes back to step S701.

Conversely, if in step S703 the bit value of the current obtained bit is a second value (i.e., ‘0’), then in step S709, the pixel obtaining sub-module 320 obtains a dot matrix from the obtained dot matrix file according to the first function. In step S710, the pixel obtaining sub-module 320 obtains a pixel from the obtained dot matrix according to the second function. In step S711, the determining sub-module 321 determines whether the display property of the obtained pixel is invisible. If the display property of the obtained pixel is not invisible, the procedure goes back to step S710 to obtain a new pixel. If the display property of the obtained pixel is invisible, in step S712, the encrypting module 33 adjusts the display property of the earmarked pixel from invisible to visible, thereby generating an adjusted pixel. In step S713, the storing module 34 records the adjusted pixel and the corresponding bit value (i.e., ‘0’), and decreases the length of the bit sequence by one, whereupon the procedure goes back to step S701.

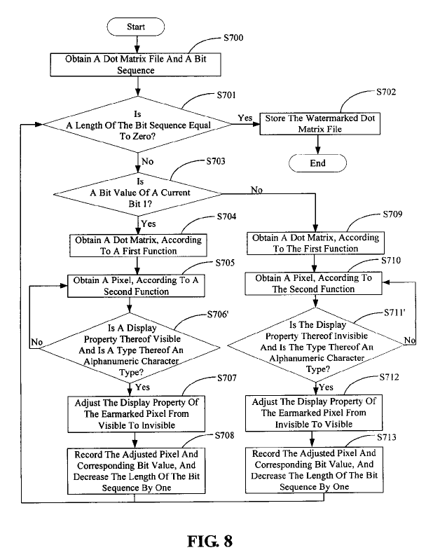

FIG. 8 is flowchart further detailing steps involved in digital watermarking utilizing a combination of the preferred methods of FIGS. 4 and 6. The steps of this flowchart are the same as those of FIG. 7, except that in steps S706′ and S711′, the determining sub-module 321 further determines whether the type of the obtained pixel is an alphanumeric character type pixel. In particular, in step S706′, if the display property of the obtained pixel is visible and if the obtained pixel is an alphanumeric character type pixel, the procedure goes to step S707. Otherwise, the procedure goes back to step S705. Similarly, in step S711′, if the display property of the obtained pixel is invisible and if the obtained pixel is an alphanumeric character type pixel, the procedure goes to step S712. Otherwise, the procedure goes back to step S710.

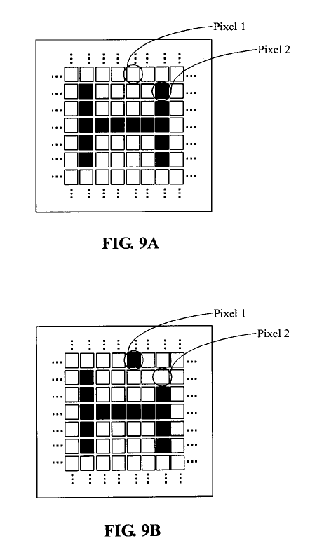

FIG. 9A is a schematic diagram showing normal display states of pixels of FIG. 2 before watermarking. For simplicity, two circled pixels (i.e., labeled as pixel 1 and pixel 2) are designated as the earmarked pixels to be adjusted. Further, the normal display properties of pixel 1 and pixel 2 are respectively invisible (i.e., indicated by a white square) and visible (i.e., indicated by a black square.)

FIG. 9B is similar to FIG. 9A, but showing the display states of the pixels after the two earmarked pixels have been adjusted. Upon watermarking, the display property of pixel 1 is changed to visible (i.e., indicated by a black square), thereby generating an adjusted pixel 1. Similarly, the display property of pixel 2 is changed to invisible (i.e., indicated by a white square), thereby generating an adjusted pixel 2.

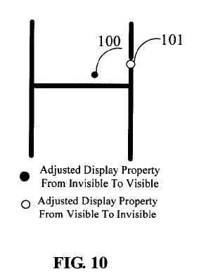

FIG. 10 illustrates adjustment results of a watermarked dot matrix obtained by utilizing the method of either FIG. 7 or FIG. 8 described above. By utilizing the steps of either FIG. 7 or FIG. 8, a dot matrix file (i.e., a text) is watermarked. For the sake of simplicity, in FIG. 10, a single watermarked alphabetic character dot matrix of the dot matrix file is illustrated; namely, the English language capital letter ‘H’. As described above, each adjusted pixel has an opposite display property as compared to its normal display property. Consequently, the pixel labeled 100 is displayed in a black mode as compared to its former white mode, and the pixel labeled 101 is displayed in a white mode as compared to its former black mode. As a result, the adjusted pixels are distinguishable from the unadjusted pixels by the human eye. This means the corresponding text has a visible difference from the normal unwatermarked text. Thereby, pirates who reproduce the text reproduce the digital watermark, and it is easier for the pirated text to be traced back to the master copy of the text.

It is to be noted that even though English language alphabetic characters are described above and/or exemplified in the drawings herein, this is for the purposes of conveniently illustrating exemplary embodiments of the present invention. The principles exemplified in the above description and drawings are equally applicable to alphabetic characters of various other languages. Further, even though Arabic numeral numeric characters are described above and/or exemplified in the drawings herein, this is for the purposes of conveniently illustrating exemplary embodiments of the present invention. The principles exemplified in the above description and drawings are equally applicable to numeric characters of various other numeral systems (such as Chinese, Japanese, etc). Moreover, even though English language punctuation mark characters are described above and/or exemplified in the drawings herein, this is for the purposes of conveniently illustrating exemplary embodiments of the present invention. The principles exemplified in the above description and drawings are equally applicable to various non-alphanumeric text characters, markings or symbols such as pronunciation symbols, asterisks, stars, hash symbols, mathematical symbols, value symbols, position symbols, etc.

It is to be further noted that although the present invention has been specifically described on the basis of preferred embodiments and preferred methods, the invention is not to be construed as being limited thereto. Various changes or modifications may be made to the embodiment and methods without departing from the scope and spirit of the invention.

What is claimed is:

1. A digital watermarking system comprising:
a storing unit for storing text information, the text information comprising one or more dot matrix files;
a text obtaining module for obtaining a dot matrix file to be watermarked from the storing unit,
wherein the dot matrix file comprises a plurality of dot matrixes, each of the dot matrixes comprises
a plurality of pixels, and each of the pixels has a display property;
a pixel determining module, for earmarking a pixel to be adjusted;
an encrypting module, for adjusting the display property of the earmarked pixel; and
a storing module, for storing watermarked text information in the storing unit.

2. The digital watermarking system according to claim 1, wherein the adjustment of the display property of the earmarked pixel is selected from the group consisting of adjusting the display property from visible to invisible and adjusting the display property from invisible to visible.

3. The digital watermarking system according to claim 2, wherein the pixel determining module further comprises a pixel obtaining sub-module and a determining sub-module, the pixel obtaining sub-module is for obtaining the pixel to be adjusted, and the determining sub-module is for determining the display property of the obtained pixel.

4. The digital watermarking system according to claim 3, wherein each obtained pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

5. The digital watermarking system according to claim 4, wherein a type of the earmarked pixel is the alphanumeric character type.

6. The digital watermarking system according to claim 5, wherein the pixel obtaining sub-module is also for obtaining a new pixel to be adjusted if a type of the obtained pixel is the punctuation type.

7. A digital watermarking method comprising the steps of:
obtaining text information to be watermarked, wherein the text information comprises one or more dot matrix files, each of the dot matrix files comprises a plurality of dot matrixes, each of the dot matrixes comprises a plurality of pixels, and each of the pixels has a display property;
earmarking a pixel to be adjusted;
adjusting the display property of the earmarked pixel; and
storing watermarked text information in a storing unit.

8. The digital watermarking method according to claim 7, wherein the adjustment of the display property of the earmarked pixel is selected from the group consisting of adjusting the display property from visible to invisible and adjusting the display property from invisible to visible.

9. The digital watermarking method according to claim 8, wherein each earmarked pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

10. The digital watermarking method according to claim 9, wherein a pixel is earmarked only if the type of the pixel is the alphanumeric character type.

11. A digital watermarking method comprising the steps of:
obtaining text information to be watermarked, wherein the text information comprises one or more dot matrix files, each of the dot matrix files comprises a plurality of dot matrixes, each of the dot matrixes comprises a plurality of pixels, and each of the pixels has a display property;
obtaining a dot matrix from the obtained text information if a length of a bit sequence is not equal to zero, wherein the bit sequence comprises an instruction for watermarking the text information;
earmarking a pixel of the obtained dot matrix according to a bit value of one bit of the bit sequence;
adjusting the display property of the earmarked pixel;
recording the adjusted pixel and corresponding bit value; and
storing watermarked text information.

12. The digital watermarking method according to claim 11, wherein the step of earmarking the pixel of the obtained dot matrix according to a bit value of one bit of the bit sequence further comprises the steps of:
obtaining a pixel from the obtained dot matrix if the bit value is equal to a first value, and earmarking the pixel if the display property of the pixel is visible; or
obtaining a pixel from the obtained dot matrix if the bit value is equal to a second value, and
earmarking the pixel if the display property of the pixel is invisible.

13. The digital watermarking method according to claim 12, wherein the step of adjusting the display property of the earmarked pixel further comprises the steps of:
adjusting the display property of the earmarked pixel from visible to invisible; or
adjusting the display property of the earmarked pixel from invisible to visible.

14. The digital watermarking method according to claim 13, wherein each earmarked pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

15. The digital watermarking method according to claim 14, wherein when the bit value is equal to the first value, a pixel is earmarked only if the display property of the pixel is visible and the type of the pixel is the alphanumeric character type; and when the bit value is equal to the second value, a pixel is earmarked only if the display property of the pixel is invisible and the type of the pixel is the alphanumeric character type.
